(19) United States
(12) Patent Application Publication
(10) Pub. No.: US 2014/0125790 A1
(43) Pub. Date: May 8, 2014

(54) Device And Method For Three Dimensional Imaging Of Biological Sample

(71) Applicant: WISCONSIN ALUMNI RESEARCH FOUNDATION, Madison, WI (US)

(72) Inventors: Thomas R. Mackie, Verona, WI (US); Kevin W. Eliceiri, Madison, WI (US); Jeremy Bredfeldt, Madison, WI (US); George Petry, Madison, WI (US)

(73) Assignee: Wisconsin Alumni Research Foundation, Madison, WI (US)

(21) Appl. No.: 13/672,380

(22) Filed: Nov. 8, 2012

(51) Int. Cl. H04N 5/225

(52) U.S. Cl. CPC H04N 5/2254
USPC 348/79

(57) ABSTRACT

A device and method are provided for generating a three dimensional image of a volume of biological material. A plurality of layers of biological material are sequentially removed therefrom. Images of each layer of the biological sample are captured prior to removal. Each image includes information from a layer and from a portion of the biological material below the layer. The information from the layer is isolated from the portion of material below the layer for each image. The three dimensional image is generated from the isolated information of each layer.

### FIELD OF THE INVENTION

The present invention relates generally to the volumetric imaging of biological material, and in particular, to a device and a method for serial imaging consecutive sections of the biological material from which a three dimensional (3D) image of the biological material may be constructed.

### BACKGROUND AND SUMMARY OF THE INVENTION

Much of our knowledge of the biological world has been obtained through the study of images. Research scientists use high resolution images to understand the workings of a cell, the development of an organism or the pathological state of a tissue. Recent developments in high resolution microscopy have allowed extra dimensions of data to be extracted from a specimen and recorded over and above the two dimensions of a simple image. The ability to analyze the microstructure of biological material in three dimensions is a valuable tool in obtaining a better understanding of the basic mechanisms of life. When coupled with fluorescence approaches, individual proteins can be fluorescently tagged and visualized for their interactions in three dimensions. Typically, the volumetric imaging of the material at the cellular level whether visible features or fluorescent utilizes the serial imaging of consecutive sections of the biological material from which a 3D image is constructed, thereby allowing for the microstructure to be “recreated.” In order to obtain the serial images, one of two types of techniques is often employed, namely, optical sectioning and physical sectioning. In optical sectioning, images are non-invasively acquired from selected depths of the biological material and reconstructed utilizing a computer. Optical sectioning microscopy, using confocal, multiphoton or deconvolution imaging, enables three-dimensional (3D) data of visible and fluorescence features to be collected, allowing visualization of a specimen's 3D structure. While functional for its intend purpose, in larger and thicker samples, structures in the interior of the biological material are often obscured by interference from structures at either side of the plane of focus, thereby diminishing the resolution of the 3D image. Furthermore, scattering and refractive index changes in biological tissue greatly limit the depths which optical sectioning can achieve.

Due to the inherent limitations on the depth resolution in optical sectioning, physical sectioning has become a sought-out method to obtain high-resolution volumetric data from biological material. In physical sectioning, typically a custom diamond knife cuts consecutive thin serial sections from a block of the biological material so as to form a ribbon which is stained and imaged. A high-sensitivity line-scan camera repeatedly samples the cut sections of the biological material at the knife-edge, prior to any subsequent deformation of section. A reconstruction technique is then used to produce a 3D image of the biological material. Alternatively, 3D images may also be assembled from individual microtomed sections. However, the assembly process is labor intensive and requires the correction of potential distortions that may be introduced during the process. Hence, the specialized equipment and/or time associated with the volumetric imaging of biological material utilizing physical sectioning can be quite expensive.

Therefore, it is a primary object and feature of the present invention to provide a device and a method for serial imaging consecutive sections of a 3D sample of biological material.

It is a further object and feature of the present invention to provide a device and a method for serial imaging consecutive sections of a 3D sample of biological material that is simple to utilize and inexpensive to construct.

It is a still further object and feature of the present invention to provide a device and method for serial imaging consecutive sections of a 3D sample of biological material for the creation of a high resolution 3D image of the biological material.

In accordance with present invention, a device for serial imaging consecutive sections of a volume of biological material is provided. The device includes a milling machine having a bit. The bit is engageable with the biological material for removing layers of biological material therefrom. A camera includes a lens directed toward the biological material. The camera captures images of the biological sample. A mount is provided for receiving the biological material thereon. The mount is movable between a first milling position adjacent the milling machine and a second image position adjacent the camera.

The mount moves from the milling position to the image position upon removal of a layer of biological material. Thereafter, the mount moves from the image position to the milling position upon the capturing of an image of the biological material adjacent the camera. A vacuum system is adjacent the milling machine. The vacuum machine clears a layer of biological material removed therefrom. Alternatively, a wiper structure removes undesired material from the biological material after a layer is removed therefrom. An image processing system generates a three dimensional image from the images captured by the camera.

In accordance with a further aspect of the present invention, a device for serial imaging consecutive sections of a volume of biological material is provided. The device includes a milling machine having a bit. The bit is engageable with the biological material for removing a plurality of layers of biological material therefrom. A camera includes a lens directed toward the biological material for capturing images of each layer of the biological sample prior to removal. Each image includes information from a layer and from a portion of the biological material below the layer. A segmentation structure is operatively connected to the camera. The segmentation structure isolates the information from the layer from the portion of material below the layer for each image. A mount receives the biological material thereon. The mount is movable between a first milling position adjacent the milling machine and a second image position adjacent the camera.

The mount moves from the milling position to the image position upon removal of a layer of biological material. Thereafter, the mount moves from the image position to the milling position upon the capturing of an image of the biological material adjacent the camera. A vacuum system is adjacent the milling machine. The vacuum machine clears a layer of biological material removed therefrom. An air stream generator may also be provided. The air stream generator generates a high pressure air stream at the biological sample directed at the layer of biological material removed therefrom. Alternatively, a wiper structure removes undesired material from the biological material after a layer is removed therefrom. An image processing system generates a three dimensional image from the images captured by the camera.

In accordance with a still further aspect of present invention, a method of generating a three dimensional image of a volume of biological material is provided. The method includes the step of sequentially removing a plurality of layers of biological material therefrom. Images of each layer of the biological sample are captured prior to removal. Each image includes information from a layer and from a portion of the biological material below the layer. The information from the layer is isolated from the portion of material below the layer for each image. The three dimensional image is generated from the information from each layer.

The method may include the step of mounting the biological material on a mount. The mount is movable between a first milling position wherein each of the plurality of layers is removed and a second image position adjacent the camera. The mount moves from the milling position to the image position upon removal of a layer of biological material. In addition, the mount moves from the image position to the milling position upon the capturing of an image of the biological material adjacent the camera. A layer of biological material is cleared after removal from the biological material. For example, a high pressure air stream may be aimed at the layer of biological material after removal from the biological material.

### BRIEF DESCRIPTION OF THE DRAWINGS

The drawings furnished herewith illustrate a preferred construction of the present invention in which the above advantages and features are clearly disclosed as well as others which will be readily understood from the following description of the illustrated embodiment.

In the drawings:

FIG. 1 is an isometric view of an imaging system in accordance with the present invention;

FIG. 2 is a schematic view of the imaging system of FIG. 1;

FIG. 3 is a schematic view of the imaging system of FIG. 1 showing the axes of movement of the component parts; and

FIG. 4 is an enlarged, schematic view of the imaging system of FIG. 1 showing removal of a first layer of sample material.

### DETAILED DESCRIPTION OF THE DRAWINGS

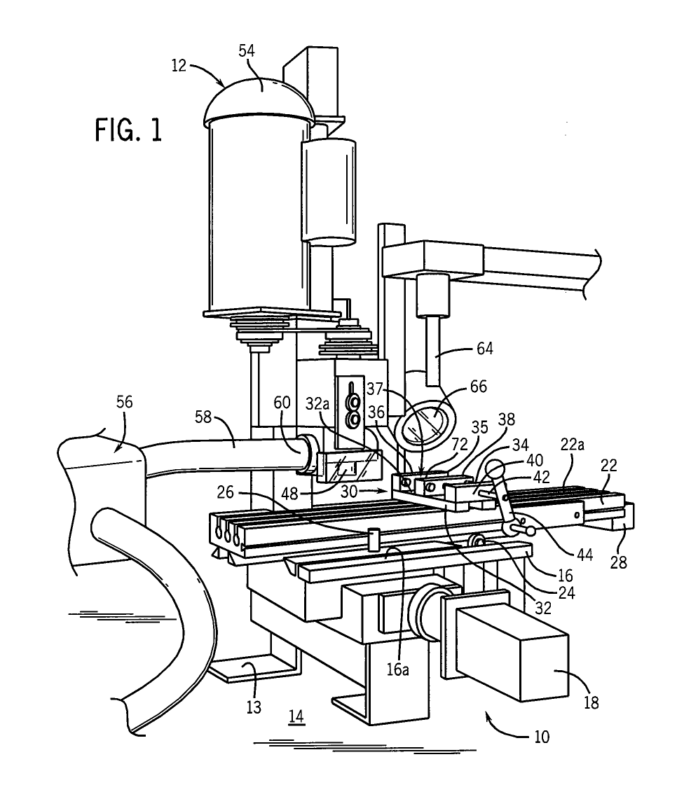

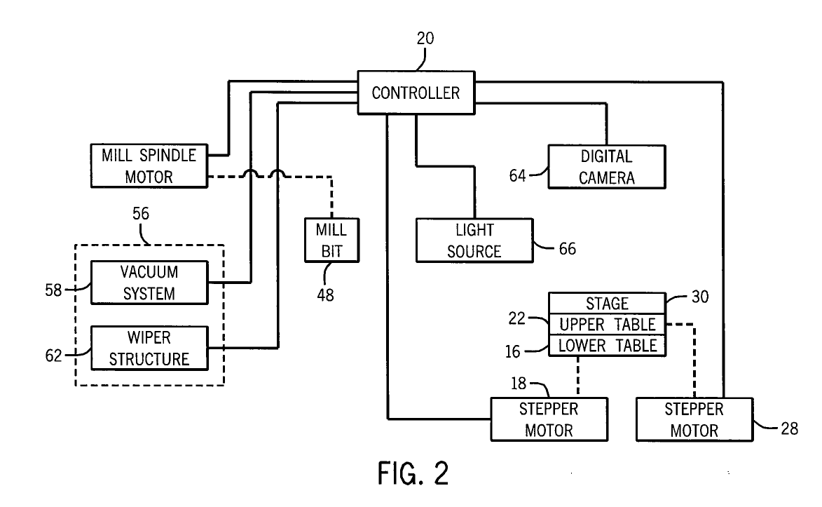

In order to effectuate the methodology of the present invention, an imaging system is provided and generally designated by the reference numeral 10, FIG. 1. Imagining system 10 includes high resolution, three axis milling machine 12. Milling machine 12 includes base 13 for supporting milling machine 12 on a supporting surface 14 such as a bench top or the like. Lower table 16 is slideably mounted connected to base 13 for axial movement along a Y-axis. Stepper motor 18 is operatively connected to table 16 and to controller 20, FIG. 2. Controller 20 selectively actuates stepper motor 18 for controlling movement of table 16 along the Y-axis.

Referring back to FIG. 1, upper table 22 is slideably supported on upper surface 16a of lower table 16 by roller bearings 24 or the like for axial movement along a X-axis. Guide pins 26 project vertically from upper surface 16a of lower table 16 on opposite sides of upper table 22 to guide movement of upper table along the X-axis. Stepper motor 28 is operatively connected to upper table 22 and to controller 20, FIG. 2. As hereinafter described, controller 20 selectively actuates stepper motor 28 for controlling movement of table 16 along the Y-axis.

Stage 30 is interconnected to upper surface 22a of upper table 22. Stage 30 includes lower portion 32 fixed to upper surface 22a of upper table 22. Upper portion 34 of stage 30 includes clamp 35 comprising first and second jaws 36 and 38, respectively, defining a sample receiving cavity 37 therebetween and support 40. First jaw 36 and support 40 are fixed to upper surface 32a of lower portion 32 of stage 30. Second jaw 38 of clamp 35 is slideably supported on upper surface 32a of lower portion 32 of stage 30 for axial movement along a Y-axis. Bolt 42 extends along the Y-axis and is threaded through support 40. Bolt 42 includes a first end fixed to second jaw 38 and a second, opposite end. Peen 44 is interconnected to the second end of bolt 42 to facilitate the threading of bolt 42 into and out of support 40. More specifically, by rotating bolt 42 in a first direction, bolt 42 urges second jaw 38 axially towards first jaw 36, thereby closing clamp 35 and reducing the length of sample receiving cavity 37. Alternatively, by rotating bolt 42 in a second, opposite direction, bolt 42 draws second jaw 38 away from first jaw 36, thereby opening clamp 35 and increasing the length of sample receiving cavity 37.

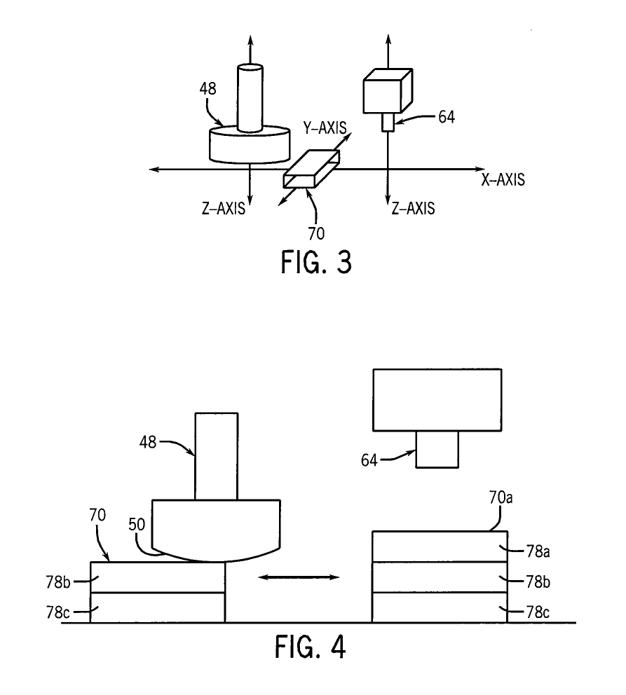

Imagining system 10 further includes mill bit 48 vertically spaced from upper surface 22a of upper table 22. As best seen in FIG. 4, mill bit 48 includes a terminal end 50 defining a generally convex milling surface for engaging a layer of biological, sample material 70, as hereinafter described. Mill bit 48 is operatively connected to mill spindle motor 54, which is slideably supported on base 13 for movement along the z-axis, FIG. 3. Actuation of mill spindle motor 54 cause rotation of mill bit 48. Controller 20 is operatively connected mill spindle motor 54 to control the actuation thereof and the speed of rotation of mill bit 48, FIG. 2. In addition, controller 20 controls vertical movement of mill spindle motor 54, and hence mill bit 48, along a Z-axis.

Imagining system 10 further includes a high resolution digital camera 64 positioned above stage 30 and cleaning system 56. Cleaning system 56 includes vacuum system 58 having an input/output 60 adjacent mill bit 48. In a first setting, vacuum system 58 generates a suction through input/output 60 to draw adjacent material therein. In a second setting, vacuum system 58 generates a high pressure air stream from input/output 60 to blow adjacent material therefrom. Cleaning system 56 may also include wiper structure 62 to remove undesired material from the upper surface of a sample, hereinafter described. Digital camera 64 includes a macroscopic lens mechanically focused on sample receiving cavity 37. Light source 66 is also directed toward sample receiving cavity 37 to illuminate the area. It can be appreciated that light source 66 may be positioned above stage 30, below stage 30 or above and below stage 30 so as to illuminate a sample received in sample receiving cavity 37. Controller 20 is operatively connected to digital camera 64 and light source 66, FIG. 2, as hereinafter described, so as to control operation of the same.

In order to effectuate the methodology of the present invention, sample material 70 (e.g. a biopsy sample of tissue) is removed from a patient for examination. Sample material 70 is fixed in an optical friendly preservation media. For example, sample material may be embedded in a matrix such as hard paraffin, a polyhydroxy-aromatic acrylic resin (e.g. LR White), or tissue freezing medium (TFM). It is intended to utilize imaging system 10 to create a high resolution three-dimensional (3D) image of sample material 70. More specifically, imaging system 10 images sample material 70 with either: 1) ambient scattered or transmitted light (from light source 66); or 2) a fluorescent imaging tag.

In operation, sample material 70 is secured to mount 72 and positioned within sample receiving cavity 37. Peen 44 is used to rotate bolt 42 in a first direction such that second jaw 38 is urged axially towards first jaw 36 thereby closing clamp 35 and capturing mount 72 (and hence, sample material 70) in sample receiving cavity 37, FIG. 1. With sample material 70 secured within sample receiving cavity 37, controller 20 actuates stepper motors 18 and 28 so as to reposition lower and upper tables 16 and 22, respectively, along the Y and X axes, respectively, (e.g. as shown in FIG. 3) such that stage 30, and hence, sample material 70 is adjacent wiper structure 62. Thereafter, controller 20 actuates wiper structure 62 and vacuum system 58 so as to remove any undesired material, e.g. dust, from upper surface 70a of sample material 70, FIG. 2.

Once the undesired material is removed from upper surface 70a of sample material 70, FIG. 4, controller 20 actuates stepper motors 18 and 28 so as to reposition upper and lower tables 16 and 22, respectively, along the Y and X axes, respectively, such that stage 30, and hence, sample material 70 is positioned within the field of view of digital camera 64. Light source 66 is activated by controller 20 and controller 20 actuates digital camera 64 such that digital camera 64 takes an image of upper surface 70a of sample material 70 or takes an image through sample material 70. The image is transmitted to controller 20, which processes the image as hereinafter described.

After digital camera 64 takes an image of upper surface 70a of sample material 70, controller 20 actuates stepper motors 18 and 28 so as to reposition upper and lower tables 16 and 22, respectively, along the Y and X axes, respectively, such that stage 30, and hence, sample material 70 is positioned in axial alignment with mill bit 48. Thereafter, controller 20 actuates mill spindle motor 54 such that mill bit 48 rotates at a desired level. In addition, controller 20 moves mill bit 48 vertically along a z-axis towards sample material 70 such that convex terminal end 50 of mill bit 48 erodes first layer 78a of sample material 70 by thickness Δz, FIG. 4. In addition, controller 20 actuates vacuum system 58 such that vacuum system 58 either generates a suction through input/output 60 to draw the eroded sample material 70 therein or generates a high pressure air stream from input/output 60 to blow the eroded sample material 70 therefrom, in accordance with the desired setting, as heretofore described.

Once first layer 78a has been milled from sample material 70 and the debris has been removed from the exposed surface of the eroded sample material 70, controller 20 actuates stepper motors 18 and 28 so as to reposition upper and lower tables 16 and 22, respectively, along the Y and X axes, respectively, such that stage 30, and hence, sample material 70 is repositioned within the field of view of digital camera 64. Once again, light source 66 is activated by controller 20 and controller 20 actuates digital camera 64 such that digital camera 64 takes a second image of sample material 70. The second image is transmitted to controller 20, which processes the second image as hereinafter described.

After digital camera 64 takes the second image of sample material 70, controller 20 actuates stepper motors 18 and 28 so as to reposition upper and lower tables 16 and 22, respectively, along the Y and X axes, respectively, such that stage 30, and hence, sample material 70 is positioned in axial alignment with mill bit 48. Thereafter, controller 20 actuates mill spindle motor 54 such that mill bit 48 rotates at a desired level. In addition, controller 20 moves mill bit 48 vertically towards sample material 70 such that convex terminal end 50 of mill bit 48 erodes second layer 78b of sample material 70 by thickness Δz. In addition, controller 20 actuates vacuum system 58 such that vacuum system 58 either generates a suction through input/output 60 to draw the eroded sample material 70 therein or generates a high pressure air stream from input/output 60 to blow the eroded sample material 70 therefrom, in accordance with the desired setting, as heretofore described.

The process is repeated until a series of digitized images of the entirety of sample material 70 is obtained. The images may then be compiled by controller 20 to construct a complete three dimensional image of sample material 70. However, as it can be appreciated, the digitized images contain information not only from the photographed surfaces of layers 78a-78c, but from below the surfaces, as well. As such, it is necessary to remove the information from below the surfaces from the digitized images such that images used to construct the three dimensional image of sample material 70 only contain information from the layers 78a-78c removed. As hereinafter described, a segmentation structure incorporating an image subtraction algorithm may be used to isolate information from the photographed surface of layers 78a-78c from the information below the surface.

As is known, a three dimensional object, such as sample material 70, can be described as a collection of cubes or voxels, each of which having a location (x,y,z), a size, and a color. Further, it can be appreciated that each two dimensional digital image of the sample material 70 is defined by pixels that contain information from all of the voxels that define layers 78a-78c of sample material 70. In other words, the voxels below the surface of the digitized image effect the image intensity at a pixel detected by digital camera 64. Hence, in order to properly reconstruct a complete three dimensional image of sample material 70, the contribution of the voxels that define each layer (e.g. layers 78a-78c) of sample material 70 to the image intensity at a pixel detected by digital camera 64 must be determined for each image and the contribution of the voxels to the image intensity detected by digital camera 64 at such pixel that define the layers (e.g. layers 78b-78c) of sample material 70 below the surface imaged must be removed.

Given that the source of light is from either light source 66 illuminating sample material 70 or a fluorescent particle within sample material 70, it can be assumed that the incident light that scatters toward imaging system 10 or the fluorescent light that is activated within sample material is invariant with depth and constant over time. Assuming a linear relationship between the image intensity of a pixel detected by digital camera 64 and the light signal reaching digital camera 64, the contribution of a voxel of first layer 78a to the image intensity detected by digital camera 64 at a selected pixel is given by the expression:

I₁=C₁ Equation (1)

wherein I₁ is the image intensity detected by digital camera 64 at the selected pixel from the voxel of first layer 78a; and C₁ is the contribution of the voxel of first layer 78a to the image intensity. The contribution of the voxel of second layer 78b to the image intensity detected by digital camera 64 at the same pixel is given by expression:

I₂=C₂e^{-μ1Δz} Equation (2)

wherein I₂ is the image intensity detected by digital camera 64 at the selected pixel from the voxel of second layer 78b; C₂ is the contribution of second layer 78b to the image at the selected pixel; μ1 is the attenuation coefficient of the image intensity through first layer 78a; and Δz is the thickness of first layer 78a.

The contribution of the voxel of third layer 78c to the image intensity detected by digital camera 64 at the same pixel is given by expression:

I₃=C₃e^{-(μ1+μ2)Δz} Equation (3)

wherein I₃ is the image intensity detected by digital camera 64 at the selected pixel from the voxel of third layer 78c; C₃ is the contribution of third layer 78c to the image at the selected pixel; μ1 is the attenuation coefficient of the image intensity through first layer 78a; μ2 is the attenuation coefficient of the image intensity through second layer 78b; and Δz is the thickness of each layer.

Hence, the total image intensity detected by digital camera 64 at the selected pixel for a three layer, sample material 70 is given by expression:

Iₜₒₜₐₗ=I₁+I₂+I₃ Equation (4)

After first layer 78a is removed, it can be appreciated that the total image intensity of the pixel detected by digital camera 64 is given by the expression:

I₂ₜₒₜₐₗ=I₂+I₃ Equation (5)

wherein I₂ is the contribution of the voxel of second layer 78b to the image intensity detected by digital camera 64 at the same pixel and is calculated according to the expression:

I₂=C₂ Equation (6)

wherein I₂ is the image intensity detected by digital camera 64 at the selected pixel from the voxel of second layer 78b; and C₂ is the contribution of second layer 78b to the image at the selected pixel; and

I₃=C₃e^{-(μ2)Δz} Equation (7)

wherein I₃ is the image intensity detected by digital camera 64 at the selected pixel from the voxel of third layer 78c; C₃ is the contribution of third layer 78c to the image at the selected pixel; μ2 is the attenuation coefficient of the image intensity through second layer 78b; and Δz is the thickness of second layer 78b.

It can be appreciated that if there is strong attenuation of the image intensity in sample material 70, the image intensity of detected by digital camera 64 at the selected pixel for a given layer i may be calculated according to the expression:

Iₙ=Cₙ Equation (8)

wherein: Iₙ is the image intensity detected by digital camera 64 the selected pixel for the given layer n; and Cₙ is the contribution from the voxel of layer n.

As such, image Iₙ requires no correction from the contributions of lower layers. Alternatively, if the attenuation of the image intensity in sample material 70 is zero, then the image intensity detected by digital camera 64 at the selected pixel for the given layer n may be calculated according to the expression:

Iₙ−Iₙ₊₁=Cₙ Equation (9)

wherein: Iₙ is the image intensity detected by digital camera 64 at the selected pixel for the given layer n; Iₙ₊₁ is the image intensity detected by digital camera 64 at the selected pixel for layer n+1; and Cₙ is the contribution to the image intensity from the voxel of layer n.

For a three layer sample material 70, the total image intensity I detected at a pixel by digital camera 64 may be written in matrix form as:

$$I = ( {I}_{1} , {I}_{2} , {I}_{3} ) = ( \begin{matrix}1 & {e}^{- μ 1 Δ z} & {e}^{- ( μ 1 + μ 2 ) Δ z} \\ 0 & 1 & {e}^{- μ 2 Δ z} \\ 0 & 0 & 1\end{matrix} ) ( \begin{matrix}{C}_{1} \\ {C}_{2} \\ {C}_{3}\end{matrix} )$$

Assuming that the attenuation of each layer is small, known and nearly invariant with depth of a corresponding layer, the matrix may be rewritten as a series of equations, each representing a corresponding image. More specifically, the total image intensity of the first image detected by digital camera 64 at the selected pixel may written as follows:

I₁=C₁+C₂e^{-μ}^{₁}^{Δz}+C₃e^{-(μ}^{₁}^{+μ}^{₂}^{)Δz} Equation (10)

The total image intensity of the second image detected by digital camera 64 at the selected pixel may written as follows:

I₂=C₂+C₃e^{-μ}^{₂}^{Δz} Equation (11)

As such, the difference between the image intensity detected by digital camera 64 at the selected pixel for the first image and the image intensity detected by digital camera 64 at the selected pixel for the second image may be rewritten as follows:

I₁−I₂=C₁−C₂(1−e^{-μ}^{₁}^{Δz})+C₃e^{-μ}^{₂}^{Δz}(1−e^{-μ}^{₁}^{Δz}) Equation (12)

which may be further rewritten as:

C₁−C₂(1−e^{-μ}^{₁}^{Δz})+C₃e^{-μ}^{₂}^{Δz}(1−e^{-μ}^{₁}^{Δz})=C₁−C_{eff}(1−e^{-μ}^{₁}^{Δz}) Equation (13)

wherein C_{eff} is the contribution of all the layers below first layer 78a to the image at the selected pixel; μ1 is the attenuation coefficient of the image intensity through first layer 78a; and Δz is the thickness of each layer.

The light production (either scattered light or fluorescent light) value C₁ is given by the difference in images and a correction term:

C₁=I₁−I₂C_{eff}(1−e^{-μ}^{₁}^{Δz}) Equation (14)

Assuming the product of attenuation coefficient μ₁ of the image intensity through first layer 78a and the thickness Δz of first layer 78a is small, the contribution C₁ of the voxel of first layer 78a to the image intensity may be rewritten as:

μₙ≈I₁−I₂+μ₁ΔzC_{eff} Equation (15)

The above equation is generalized to layer n with the equation below:

Cₙ=Iₙ−Iₙ₊₁+μ₁ΔzC_{eff,n+1} Equation (16)

wherein Cₙ is the contribution of the voxel of the top, nth layer (e.g., layers 78a-78c) to the image intensity; C_{eff,n+1} is the contribution of the contribution of all the layers below nth layer (e.g., layers 78b-78c) to the image at the selected pixel; μ1 is the attenuation coefficient of the image intensity through the nth layer; and Δz is the thickness of each layer.

The solution to this Equation (16) may be approximated by a three step process. In the first step, the contributions of each of n layers (e.g., layers 78a-78c) are estimated according to the expression:

Cₙ_{_{—}}ₑₛₜ=Iₙ−Iₙ₊₁ Equation (17)

wherein Cₙ_{_{—}}ₑₛₜ is the estimated contribution of the voxel of the exposed layer (e.g., layers 78a-78c) to the image intensity; Iₙ is the image intensity detected by digital camera 64 at the selected pixel for the exposed layer (e.g., layers 78a-78c); and Iₙ₊₁ is the image intensity detected by digital camera 64 at the selected pixel for the n+1 layer (e.g., layers 78b-78c). Equation (17) is then solved for each of the n layers (e.g., layers 78a-78c) of sample material 70.

Second, using the estimated contributions Cₙ_{_{—}}ₑₛₜ of each of n layers (e.g., layers 78a-78c) calculated as heretofore described, the attenuation coefficients μₙ for each the n layers may be estimated according to the expression:

$${μ}_{n} = - \frac{ln \frac{max ( {C}_{n\_est} … {C}_{n\_est + k} )}{{C}_{n\_est}}}{Δ {z}_{m}} \qquad Equation ( 18 )$$

wherein μₙ is the attenuation coefficient of the nth layer (e.g., layers 78a-78c), k is an empirical constant and Δzₘ is the distance from the max Cₙ_{_{—}}ₑₛₜ to the current Cₙ_{_{—}}ₑₛₜ. Equation (18) is then solved for each of the n layers (e.g., layers 78a-78c) of sample material 70.

Finally, it can be appreciated that Equation (16) may be rewritten as follows to incorporate the estimated value of the p coefficient of the nth layer (e.g., layers 78a-78c) from Equation (18) and to approximate C_{eff,n+1} as Cₙ_{_{—}}ₑₛₜ₊₁:

Cₙ=Cₙ_{_{—}}ₑₛₜ+μₙΔzCₙ_{_{—}}ₑₛₜ₊₁ Equation (19)

Utilizing Equation (19), the contribution Cₙ of the voxel of the nth layer (e.g., layers 78a-78c) to the image intensity is calculated. Equation (19) is then solved for each of the n layers (e.g., layers 78a-78c) of sample material 70 to compute the contributions G for each layer n within sample material 70. It is noted that the above process may be iterated to converge on a more accurate estimate of G.

Once the contributions Cₙ of the voxel for each layer n within sample material 70 to the image intensity are computed, the image of a layer (e.g., layers 78a-78c) may be reconstructed by carrying out this process for each (x,y) pixel location. It can be understood that the contribution from any given 3D location with sample material 70 may be expressed as C_{x,y,n}.

Alternatively, in order to deduct the attenuation coefficients μₙ for each of the n layers of sample material 70, it is contemplated to illuminate sample material 70 from below with a uniform, collimated light source at or close to the wavelength of the light emanating from light source 66 illuminating sample material 70 or from a fluorescent particle within sample material 70. Given the light emanating from the collimated light source has a constant intensity Q₀, the intensity of the light emanating through layers 78a-78c from the collimated light source may be calculated according to the expressions:

Q₁/Q₀=e^{-(μ1+μ2+μ3)Δz} Equation (20)

wherein Q₁ is the intensity of the light emanating through layers 78a-78c from the collimated light source.

Q₂/Q₀=e^{-(μ2+μ3)Δz} Equation (21)

wherein Q₂ is the intensity of the light emanating through layers 78b-78c from the collimated light source.

Q₃/Q₀=e^{-(μ3)Δz} Equation (22)

wherein Q₃ is the intensity of the light emanating through layer 78c from the collimated light source.

Given the light emanating from the collimated light source has a constant intensity Q₀, attenuation coefficient μ2 of second layer 78b may be calculated according to the expression:

μ2Δz=−ln(Q₂/Q₃) Equation (23)

and attenuation coefficient μ1 of first layer 78a may be calculated according to the expression:

μ1Δz=−ln(Q₁/Q₂) Equation (24)

Given the thickness Δz of each layer 78a-78c is constant, the fluorescent or scattered light strength and the attenuation coefficients μₙ may be determined. In view of the foregoing, the methodology heretofore described for imaging sample material 70 may be modified such that after activating light source 66 and taking each image of upper surface 70a of sample material 70 with digital camera 64 as heretofore described, a uniform, collimated light source illuminates sample material 70 from below at close to the wavelength of the light emanating from light source 66 illuminating sample material 70 or from a fluorescent particle within sample material 70. In such manner, second images of upper surfaces of layers 78a-78c of sample material 70 may be taken with digital camera 64. Such images may be provided to controller 20, thereby allowing controller 20 to calculate the fluorescent or scattered light strength and the attenuation coefficients, as described.

Once image the desired digitized images for layers 78a-78c of sample material 70 are constructed, as heretofore described, controller 20 compiles the images to construct a complete three dimensional image of sample material 70. It can be appreciated that imaging system 10 of the present invention bridges the gap between conventional microscopy with its micron to sub-micron resolution and fields of view of tens or hundreds of microns, and medical imaging with its millimeter resolution with fields of view of tens of centimeters. It is contemplated for the system and methodology of the present invention to be used in a variety of applications including, but not limited to, the imaging of vascular structures or bones for developmental biology or regenerative biology studies; the imaging tumor boundaries for cancer research and drug targeting verification; and the conducting of structural analysis or quality assurance of engineered tissues.

Various modes of carrying out the invention are contemplated as being within the scope of the following claims particularly pointing out and distinctly claiming the subject matter, which is regarded as the invention.

We claim:

1. A device for serial imaging consecutive sections of a volume of biological material, comprising:
a milling machine having a bit, the bit engageable with the biological material for removing layers of biological material therefrom;
a camera including a lens directed toward the biological material, the camera capturing images of the biological sample; and
a mount for receiving the biological material thereon, the mount movable between a first milling position adjacent the milling machine and a second image position adjacent the camera.

2. The device of claim 1 wherein the mount moves from the milling position to the image position upon removal of a layer of biological material.

3. The device of claim 1 wherein the mount moves from the image position to the milling position upon the capturing of an image of the biological material adjacent the camera.

4. The device of claim 1 further comprising a vacuum system adjacent the milling machine, the vacuum machine clearing a layer of biological material removed therefrom.

5. The device of claim 1 further comprising a wiper structure to remove undesired material from the biological material after a layer is removed therefrom.

6. The device of claim 1 further comprising an image processing system for generating a three dimensional image from the images captured by the camera.

7. A device for serial imaging consecutive sections of a volume of biological material, comprising:
a milling machine having a bit, the bit engageable with the biological material for removing a plurality of layers of biological material therefrom;
a camera including a lens directed toward the biological material for capturing images of each layer of the biological sample prior to removal, each image including information from a layer and from a portion of the biological material below the layer;
a segmentation structure operatively connected to the camera, the segmentation structure isolating the information from the layer from the portion of material below the layer for each image; and
a mount for receiving the biological material thereon, the mount movable between a first milling position adjacent the milling machine and a second image position adjacent the camera.

8. The device of claim 7 wherein the mount moves from the milling position to the image position upon removal of a layer of biological material.

9. The device of claim 7 wherein the mount moves from the image position to the milling position upon the capturing of an image of the biological material adjacent the camera.

10. The device of claim 7 further comprising a vacuum system adjacent the milling machine, the vacuum machine clearing a layer of biological material removed therefrom.

11. The device of claim 10 further comprising an air stream generator, the air stream generator generating a high pressure air stream at the biological sample directed at the layer of biological material removed therefrom.

12. The device of claim 7 further comprising a wiper structure to remove undesired material from the biological material after a layer is removed therefrom.

13. The device of claim 7 further comprising an image processing system for generating a three dimensional image from the images captured by the camera.

14. A method of generating a three dimensional image of a volume of biological material, comprising:
sequentially removing a plurality of layers of biological material therefrom;
capturing images of each layer of the biological sample prior to removal, each image including information from a layer and from a portion of the biological material below the layer;
isolating the information from the layer from the portion of material below the layer for each image; and
generating the three dimensional image from the information from each layer.

15. The method of claim 14 further comprising the step of mounting the biological material on a mount, the mount movable between a first milling position wherein each of the plurality of layers is removed and a second image position adjacent the camera.

16. The method of claim 15 wherein the mount moves from the milling position to the image position upon removal of a layer of biological material.

17. The method of claim 16 wherein the mount moves from the image position to the milling position upon the capturing of an image of the biological material adjacent the camera.

18. The method of claim 14 further comprising the step of vacuuming a layer of biological material after removal from the biological material.

19. The method of claim 14 further comprising the step of generating a high pressure air stream at the layer of biological material after removal from the biological material.

20. The method of claim 14 further comprising the step of removing undesired material from the biological material after a layer of biological material after removal from the biological material.
